(19) United States
(12) Patent Application Publication
(10) Pub. No.: US 2015/0285688 A1
(43) Pub. Date: Oct. 8, 2015

(54) THERMOGRAPHIC ROUTE EXAMINATION SYSTEM AND METHOD

(71) Applicant: GENERAL ELECTRIC COMPANY, Schenectady, NY (US)

(72) Inventors: Nidhi Naithani, Bangalore (IN); Dattaraj Jagdish Rao, Bangalore (IN); Anju Bind, Bangalore (IN); Sreyashi Dey Chaki, Bangalore (IN)

(73) Assignee: GENERAL ELECTRIC COMPANY, Schenectady, NY (US)

(21) Appl. No.: 14/243,933

(22) Filed: Apr. 3, 2014

(51) Int. Cl. G01J 5/52; G01J 5/04

(52) U.S. Cl. CPC G01J 5/52; G01J 5/041; G01J 2005/0085

(57) ABSTRACT

A thermographic route examination system includes a thermographic camera, a computer readable memory device, and an analysis processing unit. The thermographic camera is coupled with a vehicle that travels along a route and senses infrared radiation emitted from the route to generate a thermal signature representative of the route. The computer readable memory device stores healthy thermal signatures representative of temperatures of at least one segment of the route that is not damaged. The analysis processing unit receives the thermal signature from the thermographic camera and to determine if the one or more segments of the route are damaged segments of the route based on the thermal signature by comparing the thermal signature of the one or more segments of the route with the one or more healthy thermal signatures to determine if the one or more segments of the route are the damaged segments of the route.

### FIELD

Embodiments of the subject matter disclosed herein relate to examining routes traveled by vehicles for damage to the routes.

### BACKGROUND

Routes that are traveled by vehicles may become damaged over time with extended use. For example, tracks on which rail vehicles travel may become broken, cracked, pitted, misaligned, or the like, over time. This damage can pose threats to the safety of the rail vehicles, the passengers located thereon, and nearby persons and property. For example, the risks of derailment of the rail vehicles can increase when the tracks become damaged.

Some known systems and methods that inspect the tracks involve emitting visible markers on the tracks and optically monitoring these markers to determine if the tracks have become misaligned. These visible markers may be created using laser light, for example. But, these systems and methods can require additional hardware in the form of a light emitting apparatus, such as a laser light source. This additional hardware increases the cost and complexity of the systems, and can require specialized rail vehicles that are not used for the conveyance of passengers or cargo. Additionally, these systems and methods typically require the rail vehicle to slowly travel over the tracks so that the visible markers can be examined.

Other known systems and methods inject electric current into the tracks and examining changes to the current to identify open circuits caused by breaks in the tracks. But, these systems and methods also may require additional hardware to inject the current and to sense the current, and may be prone to false identifications of damage to the route.

### BRIEF DESCRIPTION

In one example of the inventive subject matter described herein, a system (e.g., a thermographic route examination system) includes a thermographic camera, a computer readable memory device, and an analysis processing unit. The thermographic camera is configured to be coupled with a vehicle that travels along a route. The thermographic camera can be configured to sense infrared radiation emitted from the route and to generate a thermal signature representative of different temperatures of one or more segments of the route based on the infrared radiation that is sensed by the thermographic camera. The computer readable memory device is configured to store one or more healthy thermal signatures representative of temperatures of at least one segment of the route that is not damaged (e.g., not damaged at the time the one or more healthy thermal signatures are generated). The analysis processing unit is configured to receive the thermal signature from the thermographic camera and to determine if the one or more segments of the route are damaged segments of the route based on the thermal signature by comparing the thermal signature of the one or more segments of the route with the one or more healthy thermal signatures to determine if the one or more segments of the route are the damaged segments of the route.

In another example of the inventive subject matter described herein, a method (e.g., a thermographic route examining method) includes sensing infrared radiation emitted from a route with a thermographic camera coupled to a vehicle traveling on the route, generating a thermal signature representative of different temperatures of one or more segments of the route based on the infrared radiation that is sensed, and examining the thermal signature to determine if the one or more segments of the route are damaged segments of the route based on the thermal signature by comparing the thermal signature of the one or more segments of the route with one or more healthy thermal signatures representative of temperatures of at least one segment of the route that is not damaged.

In another example of the inventive subject matter described herein, another system (e.g., a thermographic route examining system) includes a thermographic camera, a computer readable memory device, and an analysis processing unit. The thermographic camera is configured to be coupled with a rail vehicle that travels along a track, and to generate an infrared image of the track as the rail vehicle moves on the track. The computer readable memory device is configured to store one or more healthy infrared images representative of at least one segment of the track that is not damaged. The analysis processing unit is configured to examine the infrared image and identify differences in temperatures of the track. The analysis processing unit also is configured to identify one or more areas of interest in the infrared image based on the differences by comparing the infrared image of the track with the one or more healthy infrared images to determine if the track is damaged. The one or more areas of interest can represent damaged locations of the track.

### BRIEF DESCRIPTION OF THE DRAWINGS

Reference is made to the accompanying drawings in which particular embodiments and further benefits of the invention are illustrated as described in more detail in the description below, in which:

FIG. 1 is a schematic illustration of a thermographic route examination system in accordance with one example of the inventive subject matter described herein;

FIG. 2 illustrates a thermal signature of a segment of a route shown in FIG. 1 according to one example of the inventive subject matter described herein;

FIG. 3 illustrates another thermal signature of a segment of the route shown in FIG. 1 according to one example of the inventive subject matter described herein;

FIG. 4 illustrates a combined thermal signature of a segment of the route shown in FIG. 1 according to one example of the inventive subject matter described herein;

FIG. 5 illustrates a thermal signature of a segment of the route shown in FIG. 1 according to another example of the inventive subject matter described herein; and

FIG. 6 illustrates a flowchart of a method for examining a route according to one example of the inventive subject matter described herein.

### DETAILED DESCRIPTION

One or more examples of the inventive subject matter described herein include systems and methods for identifying damaged segments of a route by examining temperatures of the route. Infrared technology can be used to detect thermal signatures in the route, such as in the rails of a track traveled by rail vehicles or other routes traveled by other vehicles. The thermal signatures or patterns to are used to differentiate healthy segments of the route from unhealthy segments. The term “healthy” refers to the extent of damage to the route. For example, a healthy segment of a route can include the portion of the route that has no damage or has a sufficiently reduced amount of damage that vehicles can travel on the route at or near an upper speed limit of the route (e.g., track speed).

In one aspect, a thermographic or infrared (IR) camera is mounted on a vehicle, and may be oriented toward the route being traveled upon. As the vehicle moves along the route, infrared images are captured from the route. The images of the route can be analyzed after the vehicle has passed over the route to obtain heat patterns, or thermal signatures, of the route. The thermal signatures for healthy and unhealthy (e.g., damaged) routes are compared to identify those segments of the route that are damaged.

When the damaged segment of the route is identified, one or more other responsive actions may be initiated. For example, a warning signal may be communicated (e.g., transmitted or broadcast) to one or more other vehicles to warn the other vehicles of the damage, a warning signal may be communicated to one or more wayside devices disposed at or near the route so that the wayside devices can communicate the warning signals to one or more other vehicles systems, a warning signal can be communicated to an off-board facility that can arrange for the repair and/or further examination of the damaged segment of the route, or the like.

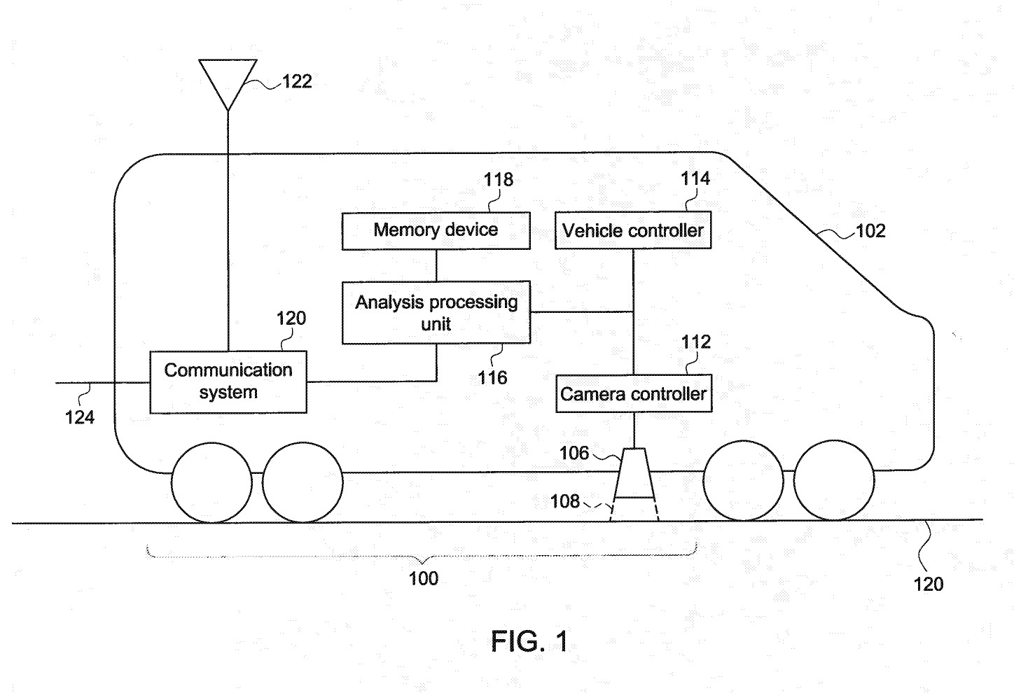

FIG. 1 is a schematic illustration of a thermographic route examination system 100 in accordance with one example of the inventive subject matter described herein. The system 100 is disposed onboard a vehicle 102, such as a rail vehicle. The vehicle 102 can be connected with one or more other vehicles, such as one or more locomotives and rail cars, to form a consist that travels along a route 120, such as a track. Alternatively, the vehicle 102 may be another type of vehicle, such as another type of off-highway vehicle (e.g., a vehicle that is not designed or is not permitted to travel on public roadways), an automobile, or the like. In a consist, the vehicle 102 can pull and/or push passengers and/or cargo, such as in a train or other system of vehicles.

The system 100 includes one or more thermographic cameras 106 mounted or otherwise connected with the vehicle 102 so that the camera 106 moves with the vehicle 102 along the route 120. The thermographic camera 106 is oriented such that a field of view 108 of the camera 106 includes a portion of the route 120. For example, the thermographic camera 106 can be disposed beneath the vehicle 102 as shown in FIG. 1, and/or may be disposed on the front, back, or side of the vehicle 102 and oriented in a generally downward direction toward the route 120. The field of view 108 of the camera 106 represents the space that is captured on images generated by the camera 106.

The camera 106 senses infrared radiation emitted by the route 120. This infrared radiation can represent different temperatures of the route 120. For a route 120 that is not damaged or not significantly damaged, the temperatures of different locations in the route 120 may be the same or approximately the same (e.g., within a designated range such as 0.5, 1, 1.5, 2 degrees Celsius, or the like). But, for a route 120 that is damaged, such as by having breaks through a rail of the route 120, pitting in the route 120, undulations in the route 120, the temperatures at different locations of the route 120 may be different. For example, a break in a rail of the route 120 may include an air gap, which can have a different temperature than the other parts of the rail due to air, condensation, or other debris being inside the air gap. Similarly, pits, cracks, or the like, in the route 120 may be at least partially filled with air, condensation, or debris, which causes the pits, cracks, or the like to have different temperatures than the other parts of the route 120. Undulations in a rail of the route 120 may cause different locations of the route 120 to be spaced farther from the underlying surface of the ground, ballast material, or the like. These different distances between the rail and the underlying surface can cause different locations of the rail to have different temperatures. The camera 106 may be an infrared camera that senses or otherwise detects the infrared radiation emitted from the route 120. As a result, the camera 106 senses or otherwise detects the different temperatures of the route 120.

The camera 106 may sense the infrared radiation from the route 120 while the vehicle 102 is moving at relatively fast speeds. For example, the infrared radiation may be detected while the vehicle 102 is moving at or near an upper speed limit of the route 120, such as the track speed of the route 120 when maintenance is not being performed on the route 120 or the upper speed limit of the route 120 has not been reduced.

The camera 106 can operate based on signals received from a camera controller 112. The camera controller 112 includes or represents one or more hardware circuits or circuitry that includes and/or is coupled with one or more computer processors (e.g., microprocessors) or other electronic logic-based devices. The camera controller 112 activates the camera 106 to cause the cameras 106 to sense infrared radiation from the route 120.

The camera 106 generates thermal signatures of the route 120 that are representative of the different temperatures of segments of the route 120. The thermal signatures are based on the infrared radiation that is sensed by the camera 106. For example, the thermal signatures can be infrared images of the route 120. As described herein, the thermal signatures can indicate different temperatures of different locations of the route 120, and can be examined to determine where the route 120 is damaged.

An analysis processing unit 116 examines the thermal signatures generated by the camera 106 to identify damaged segments of the route 120. The analysis processing unit 116 can include or represent one or more hardware circuits or circuitry that includes and/or is coupled with one or more computer processors (e.g., microprocessors) or other electronic logic-based devices. The analysis processing unit 116 receives the thermal signatures from the camera 106 and examines the thermal signatures to determine if one or more segments of the route 120 are damaged. As described herein, this examination of the thermal signatures can include comparing a thermal signature from the camera 106 to one or more previously acquired thermal signatures of the route 120, comparing a thermal signature from the camera 106 to a baseline thermal signature representative of calculated or estimated temperatures of the route 120, combining a thermal signature with one or more other thermal signatures of the route 120, or the like.

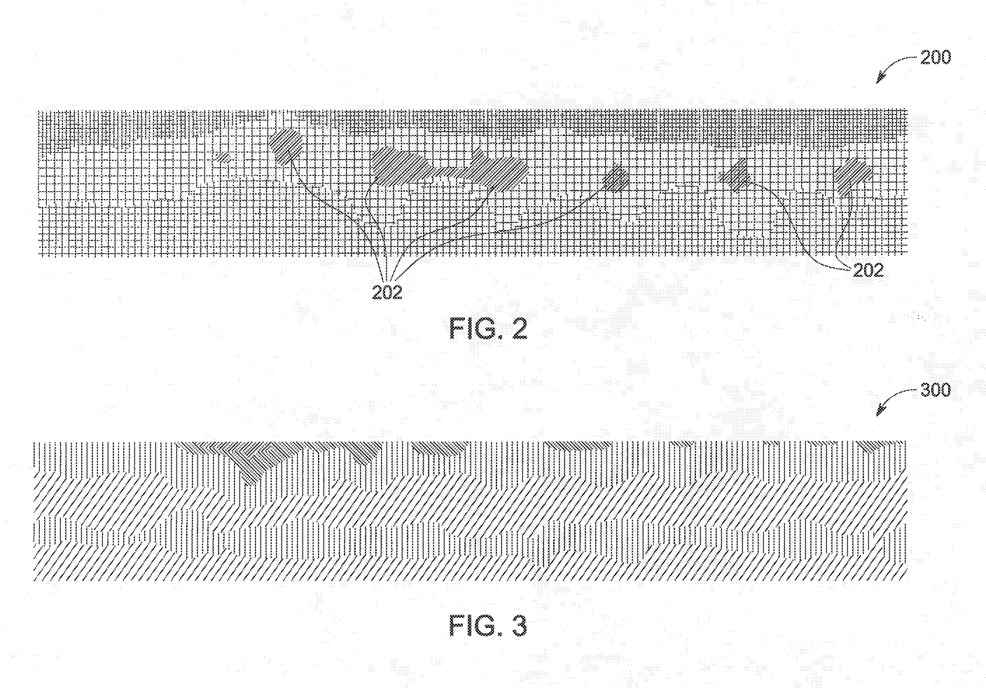

FIG. 2 illustrates a thermal signature 200 of a segment of the route 120 shown in FIG. 1 according to one example of the inventive subject matter described herein. The thermal signature 200 can include different colors, intensities, or the like, which represent the different temperatures of the segment of the route 120, as sensed by the camera 106. In one aspect, the thermal signature 200 can represent the temperatures of one rail of the route 120. Another camera 106 may generate another thermal signature for another rail of the route 120, or one camera 106 may generate thermal signatures for plural rails of the route 120. The analysis processing unit 116 can examine the thermal signature 200 to identify areas of interest 202 in the thermal signature 200.

The areas of interest 202 can be identified by determining which portions of the thermal signature 200 have the same or similar (e.g., within a designated range of wavelengths) colors, the same or similar (e.g., within a designated range) intensities, or the like, and which portions of the thermal signature 200 have different (e.g., outside of the designated range) colors, intensities, or the like. In the illustrated example, the areas of interest 202 may have different colors than other portions of the thermal signature 200. For example, the areas of interest 202 may have lighter colors (e.g., closer to white than black) and/or brighter intensities than other areas of the thermal signature 200.

The differences between the areas of interest 202 and the remainder of the thermal signature 200 can indicate that the areas of interest 202 are representative of damaged portions of the route 120. For example, the areas of interest 202 may represent hotter locations of the route 120 than other areas in the thermal signature 200. In one aspect, the analysis processing unit 116 examines the differences between the areas of interest 202 and other areas of the thermal signature 200 to determine if the areas of interest 202 indicate damage to the route 120. In one embodiment, the hotter areas of interest 202 can represent locations where there is damage to the route 120, such as voids, cracks, gaps, or the like, in the route 120 that are warmer than other locations of the route 120. Alternatively, the hotter areas of interest 202 can represent locations where there is no damage or less damage to the route 120 than other areas of the route 120. For example, the locations outside of the area of interest 202 may be cooler because the air, debris, or the like, that is in the cracks, voids, gaps, and the like, in the route 120 is cooler than the remainder of the route 120.

In one aspect, the analysis processing unit 116 can examine several thermal signatures 200 obtained for the same segment or at least partially overlapping segments of the route 120 in order to identify areas of interest 202 in the thermal signatures 200. The thermal signatures 200 can be formed from the radiation sensed by the camera 106 and/or one or more other cameras 106 when the system 100 and/or one or more other systems 100 travel over the same segment of the route 120 at different times. For example, several thermal signatures of the same segment of the route 120 may be obtained at different times. The analysis processing unit 116 can compare these thermal signatures to identify changes over time in the thermal signatures. The changes may appear as the areas of interest 202, and may be identified by the analysis processing unit 116 as representative of damage to the route 120.

Returning to the description of the system 100 shown in FIG. 1, optionally, the analysis processing unit 116 can compare the thermal signature 200 (shown in FIG. 2) generated by the camera 106 with one or more healthy thermal signatures. A healthy thermal signature can represent the thermal signature that was previously obtained from a segment of the route 120 that is not damaged or is not significantly damaged (e.g., any damage extends over less than a designated fraction of the segment of the route 120). For example, during a previous pass of the system 100 over the same segment of the route 120 or over another segment of the route 120 that is known to not include significant damage, the radiation actually emitted by the segment of the route 120 can be sensed and saved by the system 100 as a healthy thermal signature.

FIG. 3 illustrates another thermal signature 300 of a segment of the route 120 shown in FIG. 1 according to one example of the inventive subject matter described herein. Similar to the thermal signature 200 shown in FIG. 2, the thermal signature 300 can include different colors, intensities, or the like, which represent the different temperatures of the segment of the route 120, as sensed by the camera 106. In one aspect, the thermal signature 300 can represent the temperatures of one rail of the route 120. Another camera 106 may generate another thermal signature for another rail of the route 120, or one camera 106 may generate thermal signatures for plural rails of the route 120.

One difference between the thermal signature 300 and the thermal signature 200 shown in FIG. 2 is that the thermal signature 300 may be a healthy thermal signature that is generated from radiation emitted by a segment of the route 120 that does not include significant damage. As described above, the healthy thermal signature 300 may be obtained by a previous pass of the system 100 (shown in FIG. 1) over the segment of the route 120.

The healthy thermal signature 300 may be stored in a memory device 118 (shown in FIG. 1) of the system 100. The memory device 118 includes or represents one or more memory devices, such as a computer hard drive, a CD-ROM, DVD ROM, a removable flash memory card, a magnetic tape, or the like. The memory device 118 can be disposed onboard the vehicle 102 or off-board the vehicle 102. For example, a communication system 120 (shown in FIG. 1) may be disposed onboard the vehicle 102 to allow the vehicle 102 to communicate with one or more off-board components or other vehicles. The communication system 120 represents hardware circuits or circuitry that include and/or are connected with one or more computer processors (e.g., microprocessors) and communication devices (e.g., wireless antenna 122 and/or wired connections 124) that operate as transmitters and/or transceivers for communicating signals with one or more locations disposed off-board the vehicle 102. For example the communication system 120 may wirelessly communicate signals via the antenna 122 and/or communicate the signals over the wired connection 124 (e.g., a cable, bus, or wire such as a multiple unit cable, train line, or the like) to a facility and/or another vehicle system or consist, to another vehicle in the same vehicle system or consist, or the like. If the healthy thermal signature 300 is not stored onboard the vehicle 102, then the analysis processing unit 116 can wirelessly obtain or receive the healthy thermal signature 300 from a memory device disposed off-board the vehicle 102.

Different healthy thermal signatures 300 may be associated with different segments of the route 120. A vehicle controller 114 (shown in FIG. 1) of the vehicle 102 can be used to manually and/or autonomously control movement of the vehicle 102, and can track where the vehicle 102 is located when the thermal signatures 200 are obtained. For example, the vehicle controller 114 can include and/or be connected with a positioning system, such as a global positioning system, cellular triangulation system, or the like, to determine where the vehicle 102 is located. Optionally, the vehicle controller 114 can determine where the vehicle 102 is located based on how fast the vehicle 102 is traveling and has traveled on the route 120, how long the vehicle 102 has been moving, and the known layout of the route 120. For example, the vehicle controller 114 can calculate how far the vehicle 102 has moved from a known location (e.g., a starting location or other location). Based on the location of the vehicle 102 when the actual thermal signature 200 is obtained, the analysis processing unit 116 can obtain, from the memory device 118, the healthy thermal signature 300 that is associated with the segment of the route 120 at or near the same location of the vehicle 102.

The analysis processing unit 116 can compare the actual or current thermal signature 200 with the healthy thermal signature 300 to identify differences between the signatures 200, 300. For example, the areas of interest 202 (shown in FIG. 2) in the actual or current thermal signature 200 may not appear in the same locations as in the healthy thermal signature 300. Because the healthy thermal signature 300 can represent the radiation that is expected to be emitted by the segment of the route 120 when the segment does not have significant damage, differences between the actual thermal signature 200 and the healthy thermal signature 300 may indicate locations of damage to the route 120. For example, because the areas of interest 202 do not appear in the healthy thermal signature 300 but do appear in the actual thermal signature 200, these areas of interest 202 may be identified by the analysis processing unit 116 as damaged locations of the route 120.

Optionally, the healthy thermal signature 300 may be a baseline thermal signature. A baseline thermal signature may represent the radiation that is calculated or estimated as being emitted by the segment of the route 120 at the location of the vehicle 102 when the actual thermal signature 200 (that is to be examined) was obtained. For example, the radiation that is expected to be emitted from a healthy segment of the route 120 may be calculated from one or more thermodynamic models or equations representative of the route 120. The expected radiation can be calculated for different locations of the route 120 and used to create the healthy thermal signature 300. The analysis processing unit 116 can compare the actual thermal signature 200 to the baseline thermal signature to determine if any differences exist. The differences can represent damage to the route 120.

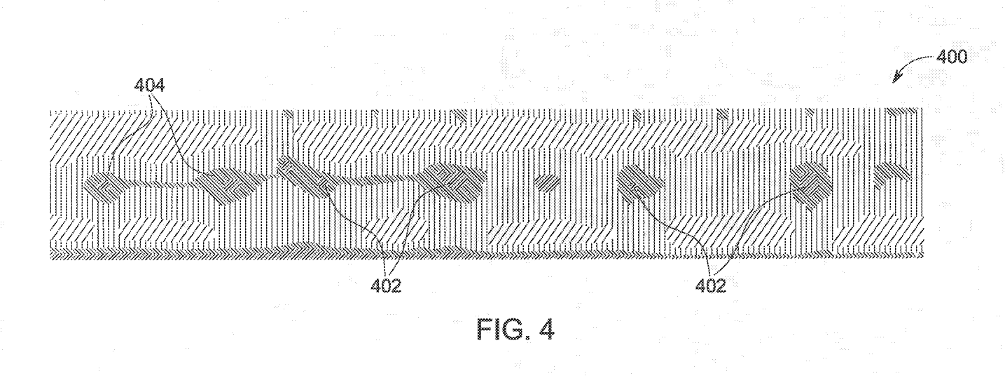

FIG. 4 illustrates a combined thermal signature 400 of a segment of the route 120 shown in FIG. 1 according to one example of the inventive subject matter described herein. Similar to the thermal signatures 200, 300 shown in FIGS. 2 and 3, the thermal signature 400 can include different colors, intensities, or the like, which represent the different temperatures of the segment of the route 120, as sensed by the camera 106. In one aspect, the thermal signature 400 can represent the temperatures of one rail of the route 120. Another camera 106 may generate another thermal signature for another rail of the route 120, or one camera 106 may generate thermal signatures for plural rails of the route 120.

One difference between the thermal signatures 200, 300 and the thermal signature 400 shown in FIG. 4 is that the combined thermal signature 400 may be formed by combining several other thermal signatures of the same or overlapping segments of the route 120.

For example, the same and/or other systems 100 may travel over the same segment of the route 120 multiple times and obtain multiple thermal signatures from these travels over the same segment of the route 120. One or more previously obtained thermal signatures may be stored on the memory device 118 onboard the vehicle 102 and/or on an off-board memory device. The analysis processing unit 116 can combine the thermal signatures by mixing the thermal signatures together, such as by calculating average, median, deviations, or the like in colors, intensities, or the like, at different locations in the thermal signatures. The averages, medians, deviations, or the like, may then be used to form the combined thermal signature 400.

The combined thermal signature 400 may be generated to filter out differences between the thermal signatures that are not due to damage to the route 120. By calculating averages, medians, deviations, or the like, of several thermal signatures based on emitted radiations that are measured at different times, the effect of external factors (such as changes in ambient temperatures, weather, or the like) on the combined thermal signature may be reduced. For example, snow, ice, or the like, on the route 120 can mask or hide damage to the route 120 in a thermal signature by reducing elevated temperatures in the thermal signature that may otherwise indicate damage to the route 120. Similarly, elevated ambient temperatures can raise the temperature of non-damaged portions of the route 120 to appear similar to damaged portions of the route 120. By combining several thermal signatures obtained at different times (and potentially under different ambient conditions), the impact of external factors that may mask or hide damage to the route 120 can be reduced.

In the illustrated example of the combined thermal signature 400, several areas of interest 402, 404 have colors and/or intensities that differ from other areas of the signature 400 (e.g., by at least a designated, non-zero threshold amount). The areas of interest 402 in the combined thermal signature 400 are disposed in the same or approximately the same locations along the route 120 as some of the areas of interest 202 shown in the thermal signature 200 (which also may be referred to as a single-pass thermal signature). As described above, these areas of interest 402 may represent damaged locations of the route 120. Additional areas of interest 404 also may represent damaged locations of the route 120. These additional areas of interest 404 do not appear in the thermal signature 200 shown in FIG. 2, potentially due to one or more external factors masking or hiding the areas of interest 404 from appearing in the thermal signature 200.

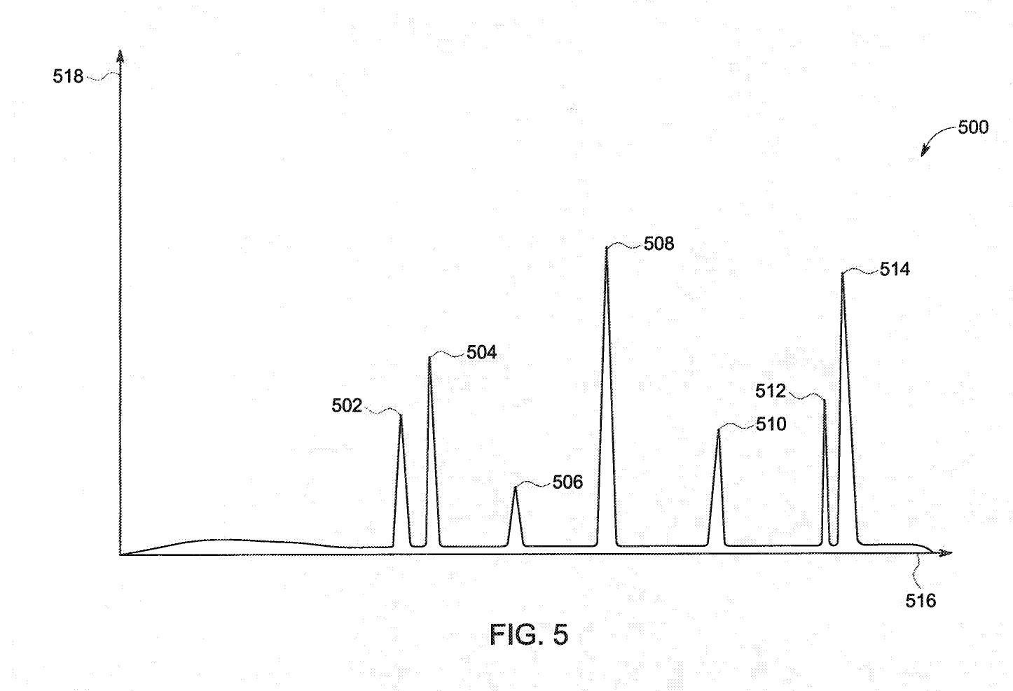

FIG. 5 illustrates a thermal signature 500 of a segment of the route 120 shown in FIG. 1 according to another example of the inventive subject matter described herein. The thermal signature 500 represents a frequency spectrum of different wavelengths of the radiation emitted by the segment of the route 120 at one or more locations along the route 120. The thermal signature 500 is shown alongside a horizontal axis 516 representative of wavelengths of radiation emitted from the route 120 and a vertical axis 518 representative of magnitudes of the wavelengths of the radiation emitted from the route 120.

The thermal signature 500 includes several peaks 502, 504, 506, 508, 510, 512, 514 representative of an increased presence or magnitude of corresponding wavelengths of the emitted radiation relative to other wavelengths of the emitted radiation. The thermal signature 500 may be generated by the analysis processing unit 116 (shown in FIG. 1). For example, the camera 106 (shown in FIG. 1) may output the radiation sensed from the route 120 to the analysis processing unit 116, which can then create the thermal signature 500 based on this sensed radiation. Optionally, the camera 106 and/or camera controller 112 (shown in FIG. 1) can generate the thermal signature 500 based on the sensed radiation and output the thermal signature 500 to the analysis processing unit 116.

The analysis processing unit 116 can examine the thermal signature 500 to determine if the thermal signature 500 indicates damage to the route 120. For example, the presence or absence of one or more peaks in the thermal signature 500, and/or the locations or relative locations of the peaks, can represent damage or a lack of damage to the route 120. The analysis processing unit 116 can compare the presence of the peaks, the locations of the peaks, and the like, to one or more predefined designated peaks associated with damage to the route 120. If the peaks in the thermal signature 500 match or are relatively close to the designated peaks, then the analysis processing unit 116 may determine that the route 120 is damaged.

If the analysis processing unit 116 determines that the route 120 is damaged, the analysis processing unit 116 can communicate a warning signal to the vehicle controller 114. This warning signal can indicate to the vehicle controller 114 that the route 120 is damaged. In response to this warning signal, the vehicle controller 114 may take one or more responsive actions. For example, the vehicle controller 114 may include an output device, such as a display, speaker, or the like, that visually and/or audibly warns an operator of the vehicle 102 of the damaged segment of the route 120. The operator may then decide how to proceed, such as by slowing or stopping movement of the vehicle, or by communicating with an off-board repair or inspection facility to request further inspection and/or maintenance of the misaligned segment of the route 120. Optionally, the vehicle controller 114 may automatically implement the responsive action, such as by automatically slowing or stopping movement of the vehicle 102 and/or automatically communicating with the off-board repair or inspection facility to request further inspection and/or maintenance of the damaged segment of the route 120.

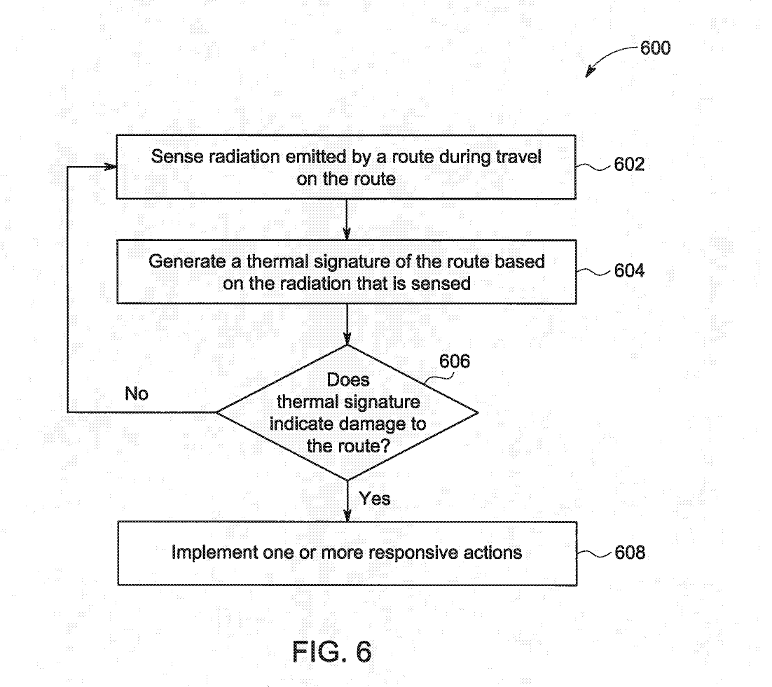

FIG. 6 illustrates a flowchart of a method 600 for examining a route according to one example of the inventive subject matter described herein. The method 600 may be used by the system 100 (shown in FIG. 1) to inspect a route being traveled by a vehicle using one or more thermographic cameras. At 602, radiation emitted by a route is sensed during movement of a vehicle along the route. As described above, one or more thermographic or infrared cameras may sense temperatures of the route during movement of the vehicle to which the cameras are connected.

At 604, one or more thermal signatures of the route are generated from the sensed radiation. For example, a thermal signature that includes different colors, intensities, or the like, associated with different temperatures of the route may be created. Optionally, the thermal signature may be a wavelength spectrum representative of the different temperatures. The thermal signature can be formed from a single pass of the thermographic camera(s) over the route, or may be a combination of several thermal signatures of the same or overlapping segments of the route.

At 606, a determination is made as to whether the thermal signature indicates damage to the route. As described above, the thermal signature can be examined to identify differences between the colors, intensities, or the like, to locate areas of interest that can represent damage to the route. Optionally, the thermal signature can be combined with several previously acquired thermal signatures to identify such differences representative of damage. In another example, the thermal signature can be compared with a healthy thermal signature and/or a baseline thermal signature to identify differences representative of damage.

If the thermal signature indicates damage to the route, then flow of the method 600 can proceed to 608. At 608, one or more responsive actions can be implemented. For example, a warning signal can be communicated to one or more other vehicles to warn the other vehicles of the damage, a warning signal can be communicated to one or more wayside devices disposed at or near the route so that the wayside devices can communicate the warning signals to one or more other vehicles, a warning signal can be communicated to an off-board facility, movement of the vehicle can be automatically slowed or stopped, an onboard operator can be notified of the damage, or the like.

If the thermal signature does not indicate damage to the route, then flow of the method 600 can return to 602, so that additional radiation of the route can continue to be monitored.

In one example of the inventive subject matter described herein, a system (e.g., a thermographic route examination system) includes a thermographic camera, a computer readable memory device, and an analysis processing unit. The thermographic camera is configured to be coupled with a vehicle that travels along a route. The thermographic camera can be configured to sense infrared radiation emitted from the route and to generate a thermal signature representative of different temperatures of one or more segments of the route based on the infrared radiation that is sensed by the thermographic camera. The computer readable memory device is configured to store one or more healthy thermal signatures representative of temperatures of at least one of the one or more segments of the route that is not damaged. The analysis processing unit is configured to receive the thermal signature from the thermographic camera and to determine if the one or more segments of the route are damaged segments of the route based on the thermal signature by comparing the thermal signature of the one or more segments of the route with the one or more healthy thermal signatures to determine if the one or more segments of the route are the damaged segments of the route.

In one aspect, the thermographic camera is configured to generate the thermal signature as an infrared image of the route having at least one of different colors or intensities to represent the different temperatures of the route.

In one aspect, the thermographic camera is configured to sense the infrared radiation emitted from the route as the vehicle is moving along the route.

In one aspect, the one or more healthy thermal signatures represent the infrared radiation actually emitted from the at least one segment of the route that is not damaged.

In one aspect, the one or more healthy thermal signatures represent the infrared radiation that was sensed by the thermographic camera or another camera at a previous time.

In one aspect, the one or more healthy thermal signatures represent one or more baseline thermal signatures, the one or more baseline thermal signatures indicating the infrared radiation that is at least one of calculated or estimated to be emitted from the at least one segment of the route that is not damaged.

In one aspect, the analysis processing unit is configured to examine the thermal signature from the thermographic camera and to obtain and examine additional thermal signatures generated by at least one of the thermographic camera or one or more additional thermographic cameras to determine if the one or more segments of the route are the damaged segments.

In one aspect, the additional thermal signatures represent previously sensed infrared radiation emitted from the route. The analysis processing unit can be configured to compare the thermal signature from the thermographic camera with the additional thermal signatures to determine if the one or more segments of the route are the damaged segments based on changes in the one or more segments of the route over time.

In one aspect, the analysis processing unit is configured to combine the thermal signature from the thermographic camera with the additional thermal signatures to generate a combined thermal signature of the one or more segments of the route. The combined thermal signature can represent at least one of an average, median, or deviation of the infrared radiation emitted by the one or more segments of the route.

In another example of the inventive subject matter described herein, a method (e.g., a thermographic route examining method) includes sensing infrared radiation emitted from a route with a thermographic camera coupled to a vehicle traveling on the route, generating a thermal signature representative of different temperatures of one or more segments of the route based on the infrared radiation that is sensed, and examining the thermal signature to determine if the one or more segments of the route are damaged segments of the route based on the thermal signature by comparing the thermal signature of the one or more segments of the route with one or more healthy thermal signatures representative of temperatures of at least one segment of the route that is not damaged.

In one aspect, the thermal signature is generated as an infrared image of the route having at least one of different colors or intensities to represent the different temperatures of the route.

In one aspect, the infrared radiation emitted from the route is sensed as the vehicle is moving along the route.

In one aspect, the one or more healthy thermal signatures represent the infrared radiation actually emitted from the at least one segment of the route that is not damaged.

In one aspect, the one or more healthy thermal signatures represent the infrared radiation that was sensed by the thermographic camera or another camera at a previous time.

In one aspect, the one or more healthy thermal signatures represent one or more baseline thermal signatures. The one or more baseline thermal signatures can indicate the infrared radiation that is at least one of calculated or estimated to be emitted from the at least one segment of the route that is not damaged.

In one aspect, the method also includes obtaining additional thermal signatures generated by at least one of the thermographic camera or one or more additional thermographic cameras. Examining the thermal signature can include examining the thermal signature and the additional thermal signatures to determine if the one or more segments of the route are the damaged segments.

In one aspect, the additional thermal signatures represent previously sensed infrared radiation emitted from the route. Examining the thermal signature can include comparing the thermal signature from the thermographic camera with the additional thermal signatures to determine if the one or more segments of the route are the damaged segments based on changes in the one or more segments of the route over time.

In one aspect, the method also includes combining the thermal signature from the thermographic camera with the additional thermal signatures to generate a combined thermal signature of the one or more segments of the route. The combined thermal signature can represent at least one of an average, median, or deviation of the infrared radiation emitted by the one or more segments of the route.

In another example of the inventive subject matter described herein, another system (e.g., a thermographic route examining system) includes a thermographic camera, a computer readable memory device, and an analysis processing unit. The thermographic camera is configured to be coupled with a rail vehicle that travels along a track, and to generate an infrared image of the track as the rail vehicle moves on the track. The computer readable memory device is configured to store one or more healthy infrared images representative of at least one segment of the track that is not damaged. The analysis processing unit is configured to examine the infrared image and identify differences in temperatures of the track. The analysis processing unit also is configured to identify one or more areas of interest in the infrared image based on the differences by comparing the infrared image of the track with the one or more healthy infrared images to determine if the track is damaged. The one or more areas of interest can represent damaged locations of the track.

In one aspect, the one or more healthy thermal signatures represent the infrared radiation actually emitted from the at least one segment of the route that is not damaged and that were previously sensed by the thermographic camera or another camera.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “an embodiment” or “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described systems and methods without departing from the spirit and scope of the inventive subject matter herein involved, it is intended that all of the subject matter of the above description or shown in the accompanying drawings shall be interpreted merely as examples illustrating the inventive concept herein and shall not be construed as limiting the inventive subject matter.

What is claimed is:

1. A system comprising:
a thermographic camera configured to be coupled with a vehicle that travels along a route, the thermographic camera also configured to sense infrared radiation emitted from the route, the thermographic camera configured to generate a thermal signature representative of different temperatures of one or more segments of the route based on the infrared radiation that is sensed by the thermographic camera;
a computer readable memory device configured to store one or more healthy thermal signatures representative of temperatures of at least one of the one or more segments of the route that is not damaged; and
an analysis processing unit configured to receive the thermal signature from the thermographic camera and to determine if the one or more segments of the route are damaged segments of the route based on the thermal signature, wherein the analysis processing unit is configured to compare the thermal signature of the one or more segments of the route with the one or more healthy thermal signatures to determine if the one or more segments of the route are the damaged segments of the route.

2. The system of claim 1, wherein the thermographic camera is configured to generate the thermal signature as an infrared image of the route having at least one of different colors or intensities to represent the different temperatures of the route.

3. The system of claim 1, wherein the thermographic camera is configured to sense the infrared radiation emitted from the route as the vehicle is moving along the route.

4. The system of claim 1, wherein the one or more healthy thermal signatures represent the infrared radiation actually emitted from the at least one segment of the route that is not damaged.

5. The system of claim 1, wherein the one or more healthy thermal signatures were sensed by the thermographic camera or another camera at a previous time.

6. The system of claim 1, wherein the one or more healthy thermal signatures represent one or more baseline thermal signatures, the one or more baseline thermal signatures indicating the infrared radiation that is at least one of calculated or estimated to be emitted from the at least one segment of the route that is not damaged.

7. The system of claim 1, wherein the analysis processing unit is configured to examine the thermal signature from the thermographic camera and to obtain and examine additional thermal signatures generated by at least one of the thermographic camera or one or more additional thermographic cameras to determine if the one or more segments of the route are the damaged segments.

8. The system of claim 7, wherein the additional thermal signatures represent previously sensed infrared radiation emitted from the route, and the analysis processing unit is configured to compare the thermal signature from the thermographic camera with the additional thermal signatures to determine if the one or more segments of the route are the damaged segments based on changes in the one or more segments of the route over time.

9. The system of claim 7, wherein the analysis processing unit is configured to combine the thermal signature from the thermographic camera with the additional thermal signatures to generate a combined thermal signature of the one or more segments of the route, the combined thermal signature representing at least one of an average, median, or deviation of the infrared radiation emitted by the one or more segments of the route.

10. A method comprising:
sensing infrared radiation emitted from a route with a thermographic camera coupled to a vehicle traveling on the route;
generating a thermal signature representative of different temperatures of one or more segments of the route based on the infrared radiation that is sensed; and
examining the thermal signature to determine if the one or more segments of the route are damaged segments of the route based on the thermal signature by comparing the thermal signature of the one or more segments of the route with one or more healthy thermal signatures representative of temperatures of at least one segment of the route that is not damaged.

11. The method of claim 10, wherein the thermal signature is generated as an infrared image of the route having at least one of different colors or intensities to represent the different temperatures of the route.

12. The method of claim 10, wherein the infrared radiation emitted from the route is sensed as the vehicle is moving along the route.

13. The method of claim 10, wherein the one or more healthy thermal signatures represent the infrared radiation actually emitted from the at least one segment of the route that is not damaged.

14. The method of claim 10, wherein the one or more healthy thermal signatures were actually sensed by the thermographic camera or another camera at a previous time.

15. The method of claim 10, wherein the one or more healthy thermal signatures represent one or more baseline thermal signatures, the one or more baseline thermal signatures indicating the infrared radiation that is at least one of calculated or estimated to be emitted from the at least one segment of the route that is not damaged.

16. The method of claim 10, further comprising obtaining additional thermal signatures generated by at least one of the thermographic camera or one or more additional thermographic cameras, wherein examining the thermal signature includes examining the thermal signature and the additional thermal signatures to determine if the one or more segments of the route are the damaged segments.

17. The method of claim 16, wherein the additional thermal signatures represent previously sensed infrared radiation emitted from the route, and examining the thermal signature includes comparing the thermal signature from the thermographic camera with the additional thermal signatures to determine if the one or more segments of the route are the damaged segments based on changes in the one or more segments of the route over time.

18. The method of claim 16, further comprising combining the thermal signature from the thermographic camera with the additional thermal signatures to generate a combined thermal signature of the one or more segments of the route, the combined thermal signature representing at least one of an average, median, or deviation of the infrared radiation emitted by the one or more segments of the route.

19. A system comprising:
a thermographic camera configured to be coupled with a rail vehicle that travels along a track, the thermographic camera configured to generate an infrared image of the track as the rail vehicle moves on the track;
a computer readable memory device configured to store one or more healthy infrared images representative of at least one segment of the track that is not damaged, wherein the analysis processing unit is configured to compare the infrared image of the track with the one or more healthy infrared images to determine if the track is damaged; and
an analysis processing unit configured to examine the infrared image and identify differences in temperatures of the track, the analysis processing unit also configured to identify one or more areas of interest in the infrared image based on the differences, the one or more areas of interest representing damaged locations of the track.

20. The system of claim 19, wherein the one or more healthy thermal signatures represent the infrared radiation actually emitted from the at least one segment of the route that is not damaged and that were previously sensed by the thermographic camera or another camera.
